(19) United States
(12) Patent Application Publication
(10) Pub. No.: US 2007/0162290 A1
(43) Pub. Date: Jul. 12, 2007

(54) SYSTEM AND METHOD FOR MANAGING PRODUCT COMPOSITION TESTING

(75) Inventors: Chung-I Lee, Tu-Cheng (TW); Hai-Hong Lin, Shenzhen (CN); Guo-Ling Ou-Yang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,217

(22) Filed: Jul. 13, 2006

(30) Foreign Application Priority Data
Jan. 12, 2006 (CN) 200610032898.6

(51) Int. Cl. G06Q 30/00

(52) U.S. Cl. 705/1

(57) ABSTRACT

An exemplary system includes a database (3), and a website (20) connected thereto. The database is configured for storing RoHS specifications, and the website is configured for information exchange with the database. The website includes a creating module (204), an uploading module (210), a RoHS checking module (212) and a storing module (214). The creating module is configured for creating a product RoHS compliance test list specifying testing items. The product composition analysis is based on a testing result. The RoHS checking module is configured for checking whether all compositions in the product composition analysis comply with the RoHS specifications. The storing module is configured for storing the product RoHS compliance test list and the product composition analysis of the product into the database, if all the compositions in the product composition analysis comply with the RoHS specifications. A related method is also provided.

### FIELD OF THE INVENTION

The present invention is generally related to systems and methods of managing product testing, and more particularly, to a system and method for managing product composition testing.

### DESCRIPTION OF RELATED ART

The restriction of hazardous substance in electrical and electronic equipment (RoHS) directive (2002/95/EC), as the name suggests, aims at the restriction of the use of certain hazardous substances in the manufacturing of electrical and electronic equipments. This directive holds companies the responsibility of placement in the EU market of electrical and electronic products containing agreed levels of lead, cadmium, mercury, hexavalent chromium, polybrominated biphenyl (PBB), and polybrominated diphenyl ether (PBDE) flame retardants beginning Jul. 1, 2006.

The limit is a calculated concentration by weight of the hazardous substance from any material of the final product that can be separated mechanically. Therefore, products or material should pass the RoHS testing before distribution into the market. Thus, before buying a product or a piece of material, buyers of manufacturers are usually given the duty of checking if the product or the material has passed the RoHS testing. Generally, the buyer asks suppliers for a RoHS testing result of the product. It is only when the RoHS testing result shows that the product passes the RoHS testing, that the buyer will decide to purchase the product. However, buyers in production enterprises generally are assigned the duty of purchasing a large number of products or material every day, making it relatively hard and difficult to manage the RoHS testing of the products or material through manual work.

What is needed, therefore, is a system and method for managing RoHS testing of products that manages RoHS testing of products regularly and efficiently.

### SUMMARY OF THE INVENTION

One preferred embodiment provides a system for managing composition testing of a product. The system includes a database, and a website connected thereto. The database is mainly configured for storing RoHS specifications, and the website is mainly configured for information exchange with the database. The website includes a creating module, an uploading module, a RoHS checking module and a storing module. Specifically, the creating module is configured for creating a product RoHS compliance test list specifying testing items of the product. The uploading module is configured for uploading a product composition analysis to the database. The product composition analysis is created based on a testing result according to the testing items in the product RoHS compliance test list. The RoHS checking module is configured for searching the database for corresponding RoHS specifications, and checking whether all compositions in the product composition analysis comply with the RoHS specifications. The storing module is configured for storing the product RoHS compliance test list and the product composition analysis of the product into the database, if all the compositions in the product composition analysis comply with the RoHS specifications.

Another preferred embodiment provides a computer-based method for managing composition testing of a product. The method includes the steps of: providing a database configured for storing RoHS specifications, and a website connected to the database and configured for information exchange with the database; creating an product RoHS compliance test list specifying testing items of the product; creating a product composition analysis based on a testing result according to the testing items in the product RoHS compliance test list; uploading the product composition analysis to the database via the website; searching the database for corresponding RoHS specifications, and checking whether all compositions in the product composition analysis comply with the RoHS specifications; and storing the product RoHS compliance test list and the product composition analysis of the product into the database, if all the compositions comply with the RoHS specifications.

Other systems, methods, features, and advantages will be or become apparent to one skilled in the art upon examination of the following drawings and detailed description.

### BRIEF DESCRIPTION OF THE DRAWINGS

FIG. 1 is a schematic diagram of a hardware configuration of a system for managing composition testing of a product in accordance with one preferred embodiment;

FIG. 2 is a schematic diagram of function modules of the website of FIG. 1; and

FIG. 3 is a flowchart of a method for managing composition testing of a product in accordance with one preferred embodiment.

### DETAILED DESCRIPTION OF THE INVENTION

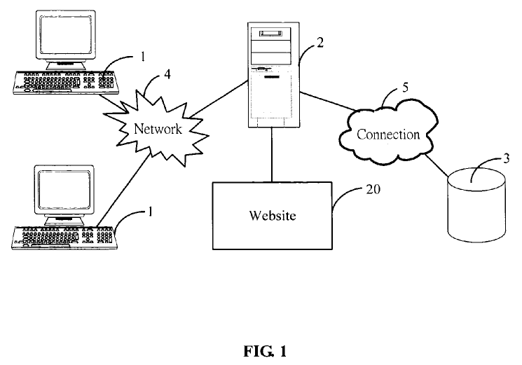

FIG. 1 is a schematic diagram of a hardware configuration of a system for managing composition testing of a product in accordance with one preferred embodiment. The system typically includes a plurality of local computers 1, an application server 2, and a database 3. The local computers 1 connect with the application server 2 via a network 4, and the application server 2 connects to the database 3 through a connection 5.

Each of the local computers 1 can be a personal computer (PC) that may include a plurality of hardware devices, such as a central processing unit (CPU), a memory, a hard-disk, a monitor, a mouse, and a keyboard (not shown). The local computer 1 may also be installed with some software, such as an operating system (OS) and application software. Using these hardware and software resources, the local computer 1 further provides a graphic user interface for a user to operate the local computer 1. The user may be a supplier that provides products, or a buyer/purchaser or any related employee of an enterprise involved in the task of buying products from the supplier.

The application server 2 may also be the PC like the local computer 1, or may be a network server computer that can process more data with a faster computing speed than a typical PC. In the preferred embodiment, the application server 2 provides a website 20 that both suppliers and purchasers can access through a local computer 1, and to have RoHS testing of products supplied by the suppliers. Furthermore, the website 20 is connected to the database 3 via the connection 5 for information and data exchange. The connection 5 may be an open database connectivity (ODBC), or a java database connectivity (JDBC).

The network 4 may be an electronic network based on a transfer control protocol and Internet protocol (TCP/IP), such as a local area network (LAN) or the Internet.

The database 3 is mainly configured for storing RoHS specifications and any other data related to RoHS testing of products, such as product RoHS compliance test lists and product composition analysis of the products. A product RoHS compliance test list of a product is generally provided by the purchaser. The product RoHS compliance test list specifies RoHS testing items of the product. The supplier of the product may send a sample of the product to a professional RoHS testing lab to test the product according to the testing items in the product RoHS compliance test list. Afterwards, the supplier may create a product composition analysis based on a testing result from the professional RoHS testing lab.

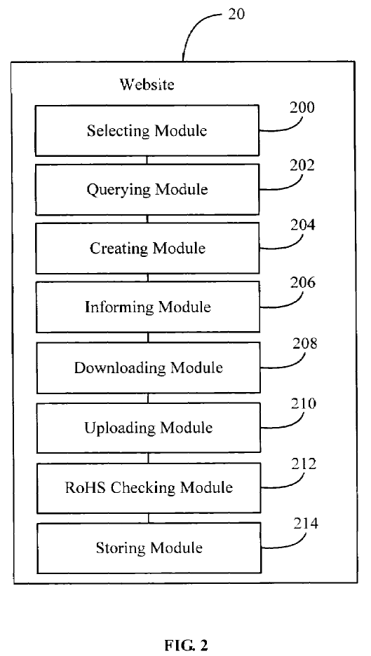

FIG. 2 is a schematic diagram of function modules of the website 20. The website 20 mainly includes a selecting module 200, a querying module 202, a creating module 204, an informing module 206, a downloading module 208, an uploading module 210, an RoHS checking module 212, and a storing module 214.

The selecting module 200 is mainly configured for selecting a product of a supplier from a product list. The website 20 typically provides a supplier list that lists a plurality of suppliers, and a product list that lists products or material that can be supplied by the suppliers in the supplier list. If a purchaser of an enterprise wants to buy a product or a piece of material, he/she may use the local computer 1 to access the website 20. The purchaser selects a combination of the product and the supplier from the product list and the supplier list respectively.

The querying module 202 is mainly configured for querying whether the product RoHS compliance test list and the product composition analysis of the selected product already exist in the database 3. If the product RoHS compliance test list and the product composition analysis of the selected product exist in the database 3, this means that the selected product has passed the RoHS testing. That is, the product complies with the RoHS Directive to put the product in the market.

The creating module 204 is mainly configured for creating a product RoHS compliance test list specifying testing items of the selected product if no product RoHS compliance test list or a product composition analysis of the selected product exist in the database 3.

The informing module 206 is mainly configured for informing the supplier of the product to download the product RoHS compliance test list via an e-mail, and informing the purchaser of the product to download the product composition analysis via an e-mail.

The downloading module 208 is mainly configured for the supplier to download the product RoHS compliance test list, and for the purchaser to download the product composition analysis.

The uploading module 210 is mainly configured for the supplier to upload the product composition analysis to the database 3 via the website 20.

The RoHS checking module 212 is mainly configured for searching in the database 3 for corresponding RoHS specifications, and checking whether all compositions in the product composition analysis comply with the RoHS specifications.

The storing module 214 is mainly configured for storing the product RoHS compliance test list and the product composition analysis of the selected product into the database 3, if all the compositions in the product composition analysis comply with the RoHS specifications.

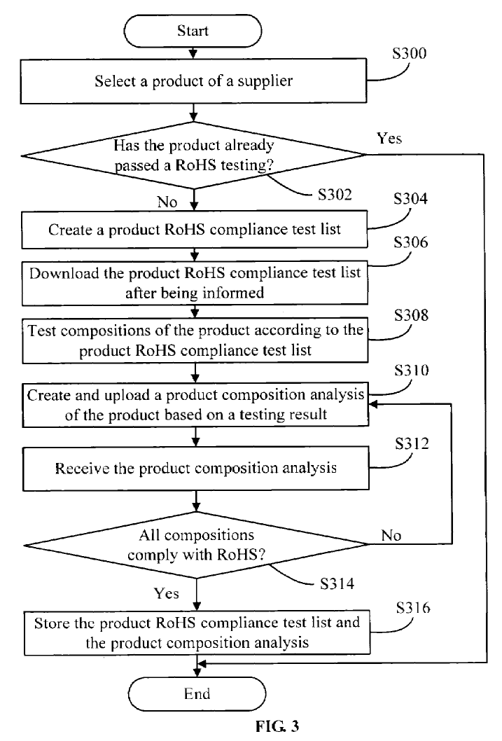

FIG. 3 is a flowchart of a method for managing composition testing of a product in accordance with one preferred embodiment. In step S300, by using the selecting module 200 the purchaser selects the product of the supplier from the product list on the website 20. In step S302, the querying module 202 queries whether the product RoHS compliance test list and the product composition analysis of the selected product exist in the database 3. If the product RoHS compliance test list and the product composition analysis of the selected product exist in the database 3, this means the selected product has been inspected and passed the RoHS testing. Furthermore, if the product RoHS compliance test and the product composition analysis of the selected product exist in the database 3, the procedure ends and the purchaser may decide to buy the product from the supplier.

If the product RoHS compliance test list or the product composition analysis of the selected product does not exist in the database 3, in step S304, the purchaser creates a product RoHS compliance test list specifying testing items of the selected product by using the creating module 204, and the informing module 206 sends an e-mail informing the supplier to download the product RoHS compliance test list.

In step S306, the supplier downloads the product RoHS compliance test list from the website 20 by using the downloading module 208 after receiving the e-mail by the informing module 206.

In step S308, the supplier of the selected product sends a sample of the product to the professional RoHS testing lab to test the compositions of the product according to the testing items in the product RoHS compliance test list.

In step S310, the supplier creates a product composition analysis based on the testing result from the professional RoHS testing lab, and uploads the product composition analysis to the website 20 by using the uploading module 210. The informing module 206 sends an e-mail to the purchaser to download the product composition analysis.

In step S312, the purchaser downloads the product composition analysis from the website 20 by using the downloading module 208. In step S314, the RoHS checking module 212 searches in the database 3 for corresponding RoHS specifications, and checks whether ails composition in the product composition analysis comply with the RoHS specifications. If all the compositions in the product composition analysis comply with the RoHS specifications, in step S316, the storing module 214 stores the product RoHS compliance test list and the product composition analysis of the selected product into the database 3. Otherwise if any composition in the product composition analysis does not comply with the RoHS specifications, the procedure returns to step S310 as described above, and the supplier may modify the product composition analysis if he/she made a typo mistake personally in creating the current product composition analysis.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for managing composition testing of a product, the system comprising:
a database configured for storing RoHS specifications;
a website connected to the database and configured for information exchange with the database, the website comprising:
a creating module configured for creating a product RoHS compliance test list specifying testing items of the product;
an uploading module configured for uploading a product composition analysis to the database, the product composition analysis being created based on a testing result according to the testing items in the product RoHS compliance test list;
a RoHS checking module configured for searching the database for corresponding RoHS specifications, and checking whether all compositions in the product composition analysis comply with the RoHS specifications; and
a storing module configured for storing the product RoHS compliance test list and the product composition analysis of the product into the database, if all the compositions comply with the RoHS specifications.

2. The system according to claim 1, wherein the website further comprises a selecting module configured for selecting the product from a product list.

3. The system according to claim 1, wherein the website further comprises a querying module configured for querying whether the product RoHS compliance test list and the product composition analysis in the database corresponding to the product exist before creating the product RoHS compliance test list and the product composition analysis.

4. The system according to claim 1, wherein the website further comprises an informing module configured for informing the supplier of the product to download the product RoHS compliance test list.

5. The system according to claim 4, wherein the informing module is further configured for informing potential purchasers of the product to download the product composition analysis.

6. The system according to claim 1, wherein the website further comprises a downloading module configured for downloading the product RoHS compliance test list.

7. A computer-based method for managing composition testing of a product, the method comprising the steps of:
providing a database configured for storing RoHS specifications, and a website connected to the database and configured for information exchange with the database;
creating an product RoHS compliance test list specifying testing items of the product;
creating a product composition analysis based on a testing result according to the testing items in the product RoHS compliance test list;
uploading the product composition analysis to the database via the website;
searching the database for corresponding RoHS specifications, and checking whether all compositions in the product composition analysis comply with the RoHS specifications; and
storing the product RoHS compliance test list and the product composition analysis of the product into the database, if all the compositions comply with the RoHS specifications.

8. The method according to claim 7, further comprising the step of selecting the product from a product list.

9. The method according to claim 7, further comprising the step of querying whether there is already an product RoHS compliance test list and a product composition analysis in the database corresponding to the product before creating the product RoHS compliance test list and the product composition analysis.

10. The method according to claim 7, further comprising the step of informing the supplier of the product of downloading the product RoHS compliance test list.

11. The method according to claim 7, further comprising the step of informing the purchaser of the product of downloading the product composition analysis.
